(19) United States
(12) Patent Application Publication
(10) Pub. No.: US 2006/0192447 A1
(43) Pub. Date: Aug. 31, 2006

(54) Apparatus and method for connecting stator phase leads

(76) Inventor: Michael D. Bradfield, Anderson, IN (US)

Correspondence Address: CANTOR COLBURN, LLP, 55 GRIFFIN ROAD SOUTH, BLOOMFIELD, CT, 06002, US

(21) Appl. No.: 11/067,840

(22) Filed: Feb. 28, 2005

(51) Int. Cl. H02K 11/00

(52) U.S. Cl. 310/71

(57) ABSTRACT

A terminal assembly for use with a stator for a dynamoelectric machine having a plurality of leads extending therefrom includes a molded body having a plurality of cavities receptive to a respective lead of the plurality of leads; and a plurality of electrically conductive terminals insert molded with the molded body. Each terminal of the plurality of terminals is configured and positioned for electrical communication with corresponding leads providing appropriate electrical connections between either or both another lead of the plurality of leads and a rectifier bridge.

### TECHNICAL FIELD

This application relates generally to the field of electrical machines. More specifically, this application relates to an apparatus and method for a neutral connection and/or termination of phase wires of a stator in a vehicle alternator.

### BACKGROUND

FIG. 1 is a cross section illustrating a conventional alternator. In FIG. 1, the alternator is provided with: a case 3 constructed from an aluminum front bracket 1 and an aluminum rear bracket 2; a shaft 6 rotatably mounted inside the case 3; a pulley 4 fastened to a first end of the shaft 6; a Lundell-type rotor 7 fastened to the shaft 6; fans 5 fastened to both axial ends of the rotor 7; a stator 8 fastened to an inner wall of the case 3 so as to cover an outer circumferential side of the rotor 7; slip rings 9 fastened to a second end of the shaft 6 for supplying electric current to the rotor 7; a pair of brushes 10 which slide in contact with the slip rings 9; a brush holder 11 for holding the brushes 10; a rectifier 12 which is electrically connected to the stator 8 to convert alternating current generated in a stator winding 16 of the stator 8 into direct current; a heat sink 17 fitted onto the brush holder 11; and a regulator 18 mounted on the heat sink 17 for adjusting the output voltage generated in the stator 8.

The rotor 7 is composed of a rotor winding 13 for generating magnetic flux on passage of electric current, and a pair of pole cores 20 and 21 disposed so as to cover the rotor winding 13. Magnetic poles are formed in the pole cores 20 and 21 by a magnetic flux generated in the rotor winding 13. The pair of pole cores 20 and 21 are made of iron, each having a number of claw-shaped magnetic poles 22 and 23 disposed on an outer circumferential perimeter at even pitch in a circumferential direction so as to project axially. The pole cores 20 and 21 are fastened to the shaft 6 facing each other such that the claw-shaped magnetic poles 22 and 23 intermesh.

The stator 8 is provided with a stator core 15 and a stator coil 16, which generates alternating current due to changes in magnetic flux produced by the rotor winding 13 accompanying the rotation of rotor 7 wound to the stator core 15.

In the automotive alternator constructed in this manner, electric current is supplied from a battery (not shown) through the brushes 10 and the slip rings 9 to the rotor winding 13, generating magnetic flux. The claw-shaped magnetic poles 22 of the pole core 20 are magnetized with north-seeking (N) poles by this magnetic flux, and the claw-shaped magnetic poles 23 of the pole core 21 are magnetized with south-seeking (S) poles. At the same time, rotational torque from the engine is transmitted through the belt and the pulley 4 to the shaft 6, rotating the rotor 7. Thus, a rotating magnetic field is applied to the stator winding 16, generating electromotive force in the stator coil 16. This alternating electromotive force passes through the rectifier 12 and is converted into direct current, the output thereof being adjusted by the regulator 18, and the battery is recharged.

The stator winding 16 of the stator 8 is generally a three-phase star (e.g., wye) connection, and the construction of the neutral-point connections therein is as shown in FIGS. 2-4. In other words, as shown in FIG. 2, the neutral-point terminals 25 are brought together in one place and connected together by twisting. Then, as shown in FIG. 3, the three twisted neutral-point terminals 25 are fastened and integrated by soldering with solder 26 to form a neutral-point joint portion 27 which is a joint portion joining the three neutral-point terminals 25. In addition, although not shown, a neutral-point lead portion is disposed on the neutral-point joint portion 27.

Then, the neutral-point lead portion extending outwards from the neutral-point joint portion 27 extends outwards from the stator core 15 together with output terminals (stator phase lead wires) 29 of each of the winding phase portions. After being bent and positioned together, the neutral point lead portion is welded, e.g., soldered, to electrically connect the wires. Then the wires and connection are insulated to prevent shorting and/or grounding. The neutral-point lead portion is then fastened and secured to the stator end turns by various means to hold it in place. The output terminals 29, in turn, are typically insulated and guided to appropriate diodes (not shown) of the rectifier 12 by a phase lead insulator (not shown). Thus, an alternator is provided in which output can be increased when the alternator is rotating at high speed by adding neutral-point voltage to the direct current output.

The neutral-point joint portion 27 is fastened and integrated by soldering the three neutral-point terminals 25, but in cases where the stator winding is constituted by two sets of the three winding phase portions, the neutral-point joint portion may be constructed by bringing six to twenty-four neutral-point terminals together in one place, connecting them by twisting them together, and fastening and integrating them by soldering.

It is desirable that the neutral-point lead portion and the output wires 29 extend outwards from the stator core 15 parallel to the axial direction to facilitate electrical connection with respective components and for eventual connection with a circuit board 12a.

Currently, however, the neutral connection on a wye wound stator includes bending the neutral phase wires together, soldering the connection point therebetween, insulating the connection point, and then securing the neutral connection point to the stator end turns by various means to hold it in place. Additionally, a separate stator phase lead insulator is used to insulate the stator phase leads extending from the stator and guide the leads to the rectifier bridge.

Accordingly, it would be desirable to accommodate connections of up to 24 or more neutral wires extending from a stator as alternators become more densely populated with electrical components and eliminate the steps of bending and forming neutral wires together and then providing a means to anchor the connection.

### BRIEF SUMMARY OF THE INVENTION

The above discussed and other drawbacks and deficiencies are overcome or alleviated by a terminal assembly for use with a stator for a dynamoelectric machine having a plurality of leads extending therefrom. The terminal assembly includes a molded body having a plurality of cavities receptive to a respective lead of the plurality of leads; and a plurality of electrically conductive terminals insert molded with the molded body. Each terminal of the plurality of terminals is configured and positioned for electrical communication with corresponding leads providing appropriate electrical connections between either or both another lead of the plurality of leads or a rectifier bridge.

In another embodiment, a method of connecting a plurality of leads extending from a stator of a dynamoelectric machine is disclosed. The method includes configuring a molded body having a plurality of cavities each receptive to a respective lead of the plurality of leads axially extending from a stator of the dynamoelectric machine; insert molding a plurality of electrically conductive terminals with the molded body, each terminal of the plurality of terminals providing appropriate electrical connections between either or both another lead of the plurality of leads or a rectifier bridge; inserting the respective lead within a corresponding cavity; and securing the respective lead within the corresponding cavity via an electrical connection between the respective lead and a respective terminal extending in the corresponding cavity.

### BRIEF DESCRIPTION OF THE DRAWINGS

FIG. 1 is a cross section view illustrating a conventional alternator;

FIG. 2 is a partial front elevation view illustrating part of a stator for mounting in a conventional alternator;

FIG. 3 is a partial front elevation view illustrating the vicinity of a neutral-point joint portion of a stator for mounting in a conventional alternator;

FIG. 4 is a cross section view taken along line IV-IV in FIG. 3 in the direction of the arrows.

FIG. 5 is a top plan flattened view of an insert molded stator lead guide and neutral connection assembly operably connected to neutral wires and phase lead wires extending from a stator in accordance with an exemplary embodiment;

FIG. 6 is an end view of the insert molded stator lead guide and neutral connection assembly of FIG. 5 illustrated in an arcuate configuration as it would abut end turns of the stator in accordance with an exemplary embodiment;

FIG. 7 is an opposite and reversed flattened end view of the molded portion of the insert molded stator lead guide and neutral connection assembly of FIG. 6 in accordance with an exemplary embodiment;

FIG. 8 is top plan view of the molded portion of the insert molded stator lead guide and neutral connection assembly of FIG. 5 in accordance with an exemplary embodiment;

FIG. 9 is an opposite end view of the molded portion of the insert molded stator lead guide and neutral connection assembly of FIG. 5 in accordance with an exemplary embodiment; and

FIG. 10 is a top plan view of the arrangement of four conductive straps that are insert molded into stator lead guide and neutral connection assembly of FIG. 5 in accordance with an exemplary embodiment.

### DESCRIPTION OF THE PREFERRED EMBODIMENT

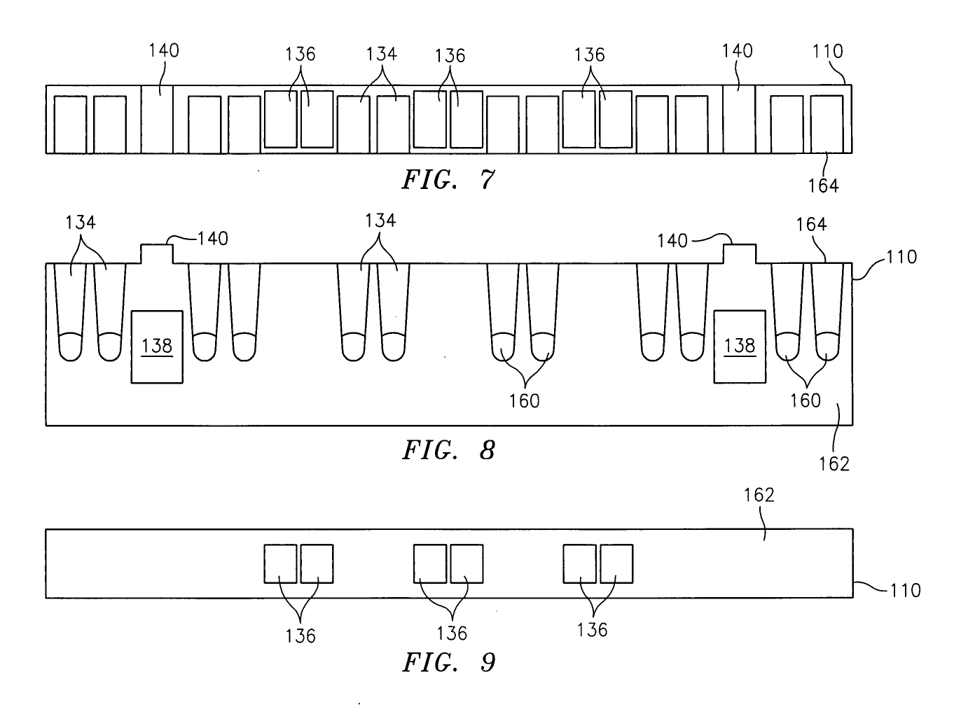

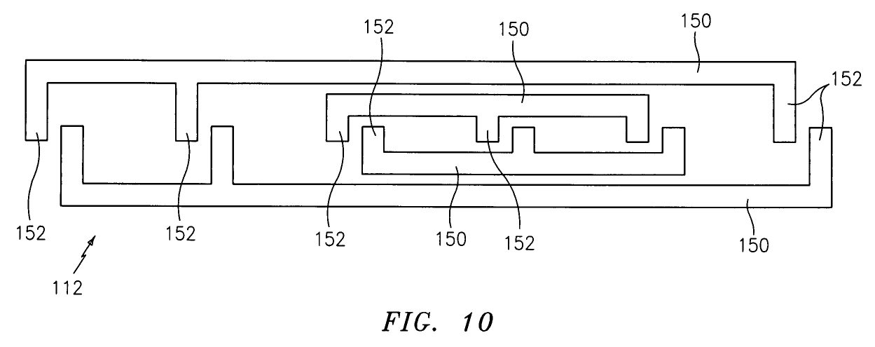

Referring to FIGS. 5-10, an exemplary embodiment of a terminal assembly configured for integrating a stator phase lead guide with a neutral connection point is shown. A terminal assembly configured as a neutral connection assembly 100 for an automotive vehicle alternator is generally described. The neutral connection assembly 100 includes a molded body 110 and electrically conductive straps or terminals 112 insert molded with molded body 110.

Referring now to FIG. 5, a plan view of an exemplary embodiment of a neutral connection assembly 100 is illustrated as it abuts end turns 119 of a stator coil 116. Molded body 110 is a molded plastic component that allows stator wires 124 to axially extend from stator coil 116 and insulates the same. Molded body 110 also provides a neutral point connection for stator wires 124 axially extending from stator coil 116 and corresponding to neutral leads indicated generally at 130. In an exemplary embodiment, molded body 110 is a phase lead insulator for wires 124 corresponding to stator phase leads 132 (six shown in FIG. 5). In this manner, molded body 110 integrates functions of a stator phase lead insulator and a stator neutral connection assembly into a single component.

Molded body 110 includes a plurality of cavities 134 (twelve shown) configured to receive a corresponding neutral lead 130 axially extending from stator coil 116. In an exemplary embodiment, as shown, cavities 134 are molded slots. Molded body 110 also includes a plurality of channels 136 extending therethrough configured to receive a corresponding stator phase lead 132 therethrough. Channels 136 guide and insulate a corresponding lead 132 as each lead 132 axially extends from stator coil 116 toward a corresponding diode for electrical connection therewith. It will be recognized that there are twelve cavities 134 and six channels 136 corresponding to a six diode rectifier bridge configuration. However, it will be recognized that molded body 110 may be configured with any number of cavities 134 and channels 136 suitable to the number of diodes.

Referring to FIGS. 5-9, it will be noted that cavities 134 and channels 136 of molded body 110 are oriented such that both cavities 134 and channels 136 are oriented in pairs such that contiguous pairs of cavities 134 are separated by a pair of channels 136 except for outboard pairs of cavities 134 defining molded body 110. The outboard pairs of cavities 134 are separated from contiguous pairs of cavities 134 by a void 138 therebetween. Void 138 is an absence of molded material allowing cooling airflow therethrough. However, other suitable configurations are contemplated suitable to the desired end purpose. Further, it is envisioned that channels 136 and cavities 134 can be enlarged to potentially be used with varying stator sizes.

In an alternative exemplary embodiment, molded body 110 may be configured to reposition the stator phase leads 132 via channels 136 for connection to the rectifier bridge. In this manner, stator phase leads 132 would continue to axially extend from the stator and terminals 112 could be insert molded like straps or terminals 112 used with neutral leads 130. In such a configuration, the stator phase leads 132 are electrically connected to an insert molded terminal 112 and then the terminal or a wire extending therefrom would exit the molded body 110 at a desired location relative to the rectifier bridge for connection therewith. Such an arrangement eliminates a need for the stator phase leads 132 to be bent into position (e.g., primarily in an angular sense) for connection with the rectifier.

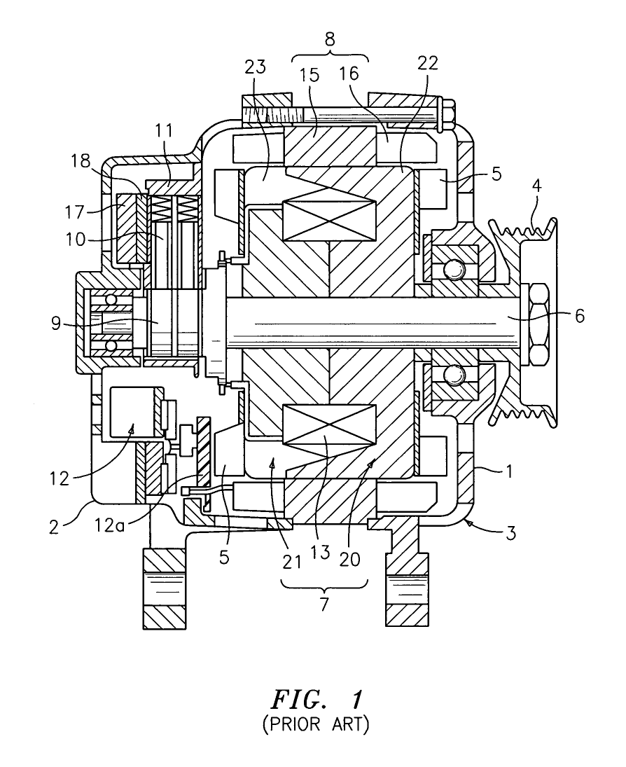

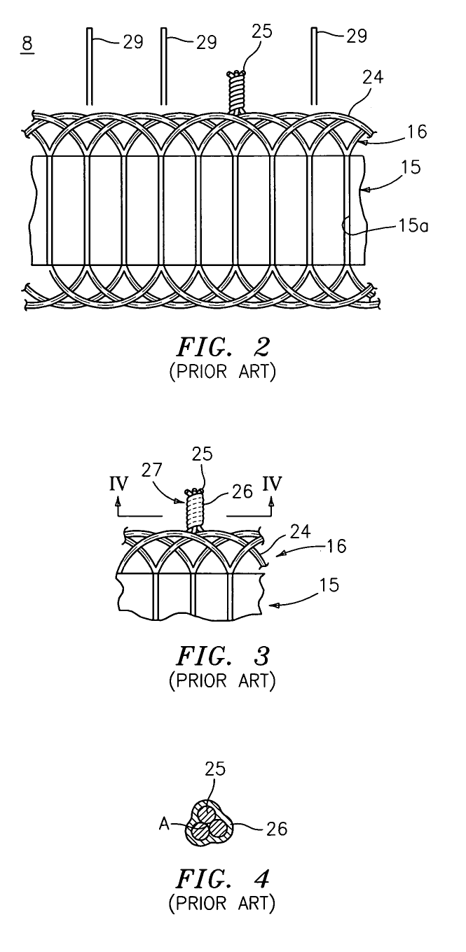

Molded body 110 optionally includes at least one standoff protrusion 140 extending therefrom. FIGS. 5-9 indicate a pair of opposing protrusions 140 aligned with voids 138 along a length defining molded body 110. Each standoff protrusion 140 abuts a portion of stator end turns 119 allowing airflow to a remaining portion of said end turns 119 not abutting protrusion 140. Airflow may be induced through void 138 and a void 142 defined between exposed end turns 119 and a facing surface portion of molded body 110. Airflow is induced through voids 138 and 142 via fans 5 of FIG. 1.

Molded body 110 electrically isolates axially extending wires 124 extending from stator coil 116 from the slip ring end (SRE) frame 2 (FIG. 1) that is at ground potential. Further, in an exemplary embodiment, molded body 110 is configured as a phase lead insulator for the stator 15 (FIG. 1) to insulate the stator wires 124 (six shown in FIG. 5) that protrude through the SRE frame 2, which is at ground potential. Molded body 110 is a molded plastic component that electrically separates stator wires 124 from SRE frame 2.

Referring again now to FIG. 5, the appropriate electrical connections between the neutral phase leads 130 are made through the use of a plurality of conductive straps or terminals 112 insert molded with molded body 110. Four straps 112 are used in a six-diode configuration as best seen with reference to FIG. 10. - In an exemplary embodiment as illustrated, each strap 112 is substantially planar and includes an extension member 150 and a plurality of branch members 152 extending therefrom. Each branch member 152 is aligned with a corresponding cavity 134 for connection with a neutral phase lead 130 extending therein. The plurality of conductive straps 112 are configured and positioned with respect to molded body 110 depending on a desired termination pattern of neutral phase leads 130.

Molded body 110 includes a plurality of openings 160 on a surface 162 normal to a surface 164 defining cavities 134. Openings 160 are molded in molded body 110, however, openings 160 may be milled after insert molding. Each opening 160 intersects a corresponding cavity 134 and extends to a corresponding branch member 152 exposing the same. Openings 160 are substantially normal to cavities 134. Openings 160 provide an access area in which to electrically connect a neutral phase lead 130 with a corresponding strap 112 via branch member 152 to form a neutral connection point with other appropriate neutral phase leads of stator wires 124 axially extending into molded body 110. In an exemplary embodiment, electrical connection between respective leads 130 and straps 112 may be formed by soldering, resistance welding, or ultrasonic welding, for example, but other suitable fastening means are contemplated. Each opening 160 provides an access area in which to conduct such welding. It will be recognized that electrical connection between respective leads 130 and straps 112 formed by welding also mechanically fixedly secures terminal assembly 100 with stator 15.

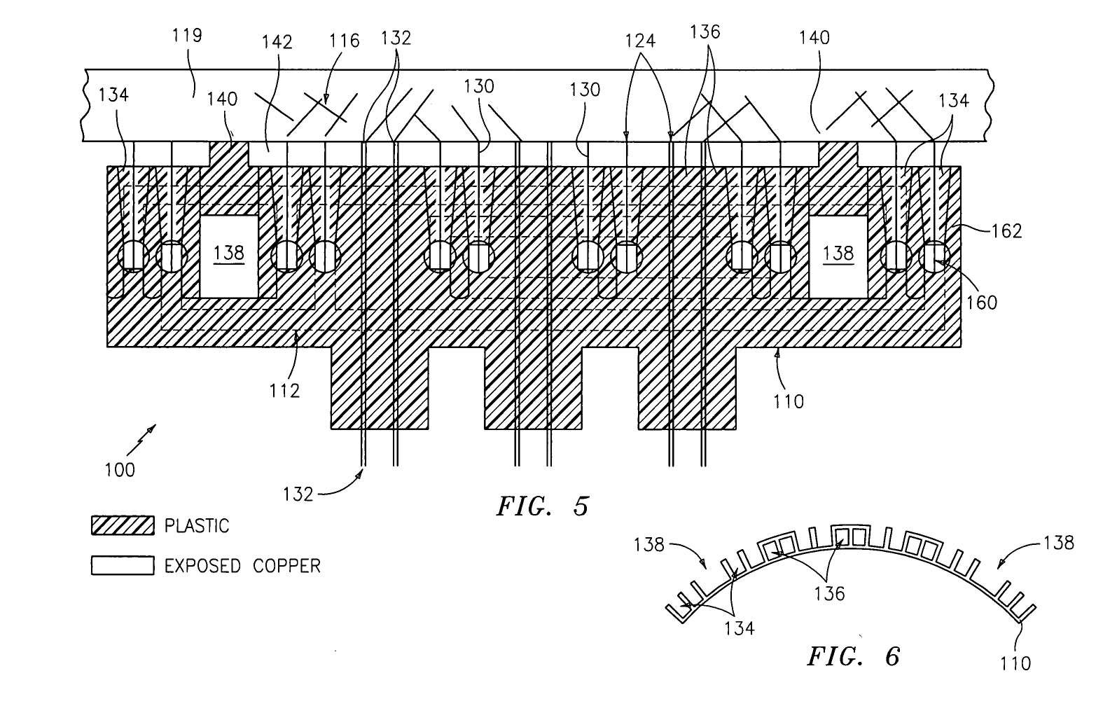

The terminal assembly or neutral connection assembly 100 is preferably configured in a circular arc fashion, as best seen with reference to FIG. 6, to match up with the curvature of the pattern of the end turns 119 of stator 15 in which it is disposed at. Molded body 110 is configured and positioned relative to stator 15 of a vehicle alternator allowing the plurality of leads to extend axially from end turns thereof eliminating any bending to form a neutral connection and/or connect with respective diodes of a rectifier bridge. Conductive straps 112 are preferably insert molded into molded body 110. Conductive straps 112 are preferably copper, but other suitably conductive materials may be employed.

The above described terminal assembly concerns neutral connection and/or termination of the phase wires of a stator. Although the terminal assembly described herein could potentially have widespread application to other rotating electrical machine designs, it is envisioned specifically for use with vehicle alternators. The neutral wires of the stator are combed straight out of the end turns in an axial direction. An electrically conductive insert in the molded body then makes the necessary routings between appropriate wires amongst the neutral wires. The stator neutral wire is welded to the insert at an exposed target weld area in the insert molded terminal assembly (e.g., via opening 160). The terminal assembly eliminates the steps of bending and forming the neutral wires together and then providing a means to anchor a resulting connection. The terminal assembly simply requires threading the axially extending stator wires into position and then welding the neutral wires therewith. In addition, the insert molded terminal assembly provides the function of a stator phase lead insulator preventing the stator wires from being grounded to the alternator frame, defining in turn a one-piece terminal assembly, which combines parts and reduces cost.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A terminal assembly for use with a stator for a dynamoelectric machine having a plurality of leads extending therefrom, the terminal assembly comprising:
a molded body, said molded body having a plurality of cavities receptive to a respective lead of said plurality of leads; and
a plurality of electrically conductive terminals insert molded with said molded body, each terminal of said plurality of terminals configured and positioned for electrical communication with corresponding leads of said plurality of leads providing appropriate electrical connections between at least one of another lead of said plurality of leads and a rectifier bridge.

2. The terminal assembly of claim 1, wherein said plurality of leads include neutral stator phase wires connected to said corresponding leads providing a neutral connection therebetween.

3. The terminal assembly of claim 1, wherein a portion of said plurality of cavities include a plurality of guides, each guide receptive to guiding and insulating a respective stator phase wire extending therethrough.

4. The terminal assembly of claim 3, wherein said each guide of said plurality of guides guide said respective stator phase wire to the rectifier bridge of the dynamoelectric machine.

5. The terminal assembly of claim 1, wherein said molded body includes an opening intersecting each cavity of said plurality of cavities and extending to a corresponding terminal, said opening providing access to fasten said respective lead with said corresponding terminal.

6. The terminal assembly of claim 1, wherein said opening provides access for welding said respective lead with said corresponding terminal.

7. The terminal assembly of claim 6, wherein said welding includes one of soldering, resistance welding, and ultrasonic welding.

8. The terminal assembly of claim 1, wherein said molded body includes at least one standoff protrusion extending therefrom, said at least one standoff protrusion abutting a portion of stator end turns of the dynamoelectric machine allowing airflow to a remaining portion of said end turns.

9. The terminal assembly of claim 1, wherein said molded body integrates functions of a stator phase lead insulator and a stator neutral connection assembly into a single component.

10. The terminal assembly of claim 1, wherein said molded body is configured and positioned relative to the dynamoelectric machine allowing said plurality of leads to extend axially from end turns thereof eliminating any bending to at least one of form a neutral connection and connect with a rectifier bridge.

11. The terminal assembly of claim 1, wherein at least one of stator phase wires and neutral wires of said plurality of leads axially extend into a respective cavity of said plurality of cavities and welded to a corresponding terminal aligned therewith.

12. The terminal assembly of claim 1, wherein said plurality of terminals includes four copper terminal inserts.

13. The terminal assembly of claim 1, wherein said plurality of conductive terminals are configured and positioned with respect to said molded body depending on a termination pattern of at least one of neutral wires and stator phase wires of said plurality of leads.

14. The terminal assembly of claim 1, wherein said plurality of guides includes six guides, one guide for each diode of a six diode rectifier.

15. The terminal assembly of claim 1, wherein said molded body is configured and positioned to insulate said plurality of leads from being grounded with a housing of the dynamoelectric machine.

16. The terminal assembly of claim 1, wherein the dynamoelectric machine includes an alternator for a vehicle.

17. A method of connecting a plurality of leads extending from a stator of a dynamoelectric machine, the method comprising:
configuring a molded body having a plurality of cavities each receptive to a respective lead of said plurality of leads axially extending from a stator of the dynamoelectric machine;
insert molding a plurality of electrically conductive terminals with said molded body, each terminal of said plurality of terminals providing appropriate electrical connections between at least one of another lead of said plurality of leads and a rectifier bridge;
inserting said respective lead within a corresponding cavity; and
securing said respective lead within said corresponding cavity via an electrical connection between said respective lead and a respective terminal extending in said corresponding cavity.

18. The method of claim 17, further comprising:
configuring an opening in said molded body intersecting each cavity of said plurality of cavities and extending to a corresponding terminal, said opening providing access to make an electrical connection via welding said respective lead with said respective strap.

19. The method of claim 17, further comprising configuring a plurality of guides, each guide receptive to guiding and insulating a respective stator phase wire extending therethrough.

20. The method of claim 19, wherein said molded body integrates functions of a stator phase lead insulator and a stator neutral connection assembly into a single component.
